(19) United States
(12) Patent Application Publication
(10) Pub. No.: US 2006/0023046 A1
(43) Pub. Date: Feb. 2, 2006

(54) Droplet application method, droplet application device, electro-optical device, and electronic apparatus

(75) Inventors: Hirotsuna Miura, Fujimi-machi (JP); Jun Amako, Matsumoto-shi (JP)

Correspondence Address: OLIFF & BERRIDGE, PLC, P.O. BOX 19928, ALEXANDRIA, VA, 22320, US

(73) Assignee: Seiko Epson Corporation, Tokyo (JP)

(21) Appl. No.: 11/145,945

(22) Filed: Jun. 7, 2005

(30) Foreign Application Priority Data
Jul. 30, 2004 (JP) 2004-223000

(51) Int. Cl. B41J 2/01

(52) U.S. Cl. 347/102

(57) ABSTRACT

A droplet application method for discharging and applying a plurality of droplets onto a substrate, comprises repetition of: providing light energy to a droplet that has been applied; and applying another droplet onto the droplet to which the light energy has been provided.

### BACKGROUND OF THE INVENTION

1. Technical Field

The present invention relates to a droplet application method, a droplet application device, an electro-optical device, and an electronic apparatus.

2. Related Art

Liquid discharge has been increasingly employed to apply liquid in processes for manufacturing electronic apparatuses. Typical application techniques by means of liquid discharge include discharging liquid droplets from a plurality of nozzles of a liquid discharge head while moving the head and a substrate relative to each other, so that droplets can be deposited on the substrate repeatedly enough to form a film. Such techniques advantageously cut down on waste in the use of liquid compared to spin coating or other application techniques, and can provide a desired pattern without using photolithography or other methods.

In addition, some application methods include discharging liquid in a columnar shape onto a substrate to increase the accuracy of deposition positions on the substrate. Japanese Unexamined Patent Publication Nos. 4-129746 and 9-101411 are examples of related art.

The related art techniques, however, involve some problems.

For example, a columnar body may be used as a gap element for defining a cell gap in a liquid crystal display. In this case, the diameter of such a columnar body is small, and the height of the body has to be set accurately. The above-mentioned application methods, however, are not for providing a columnar body on a substrate, but for simply discharging liquid in a columnar shape onto a substrate. Therefore, it is extremely difficult to provide a small diameter and height accuracy that are required for the columnar body as mentioned above.

### SUMMARY

An advantage of the invention is to provide a droplet application method and a droplet application device that provide a columnar body with a small diameter and height accuracy, and also provide an electro-optical device and an electronic apparatus that are manufactured by the droplet application method.

A droplet application method according to one aspect of the invention is to discharge and apply a plurality of droplets onto a substrate. The method includes repetition of providing light energy to a droplet that has been applied, and applying another droplet onto the droplet to which light energy has been provided.

Since the droplet application method according to the present aspect of the invention provides light energy to a droplet that has been applied, the droplet can be fixed through being dried or sintered without spreading. Another droplet is then applied onto the fixed droplet and is fixed with light energy in the same manner as mentioned above. Accordingly, a plurality of droplets are deposited to form a columnar body. A columnar body having a small diameter is thus formed, with its diameter being about the same as the diameter of the droplets. In addition, the body can be formed accurately to a desired height depending on the number of applied and deposited droplets.

A time period from applying each droplet to providing the light energy may be set based on surface energy of the droplet that has been applied. Specifically, the time period may be set appropriately to provide the light energy before the droplet spreads with its surface energy on a part onto which the droplet has been landed.

The droplet is thus fixed while its diameter remains small, so that a columnar body having a small diameter can be easily formed.

Even if a part onto which a droplet has been landed is lyophilic, the droplet is fixed while its diameter remains small, so that a columnar body having a small diameter can be easily formed irrespective of surface energy of the part onto which the droplet has been landed. Particularly, by applying a droplet on a part that has large surface energy and is lyophilic, adhesiveness between the columnar body and the substrate, for example, is increased.

The amount of the light energy to be provided is preferably determined by the material of a part onto which the droplet has been landed.

Light reflectivity differs depending on whether a part onto which a droplet has been landed is a substrate or another droplet, for example. Therefore, the amount of light energy to be provided to droplets varies even with light irradiation of the same energy amount. By determining the amount of light energy to be provided depending on the material of a part onto which a droplet has been landed, the amount of energy that is actually applied to each droplet is kept constant.

The droplet application method according to the present aspect of the invention may also include detecting a top position of the droplets that have been deposited, and adjusting a position at which the light energy is provided based on the detected top position.

Accordingly, even if the top position varies with droplets that have been deposited, light energy can be provided at an appropriate position, whereby drying or firing can be thoroughly carried out.

The top position can be detected, for example, by setting a light detector, or detecting the divergence of reflected light or the distribution of diffracted light.

The position at which the light energy is provided can also be adjusted based on the number of droplets that have been discharged by using a pre-calculated correlation between the number of droplets that have been discharged and the height of the columnar body.

The droplet application method according to the present aspect of the invention may also include applying each droplet while moving a plurality of nozzles for discharging the droplets and the substrate relative to each other. The rate of relative movement of the substrate and the frequency at which the droplets are discharged are synchronized depending on the pitch of the nozzles.

Since the droplets that have been discharged are deposited on the substrate correspondingly to the pitch of the nozzles, the substrate (or the nozzles) does not have to be stopped for forming a columnar body. Thus, waste of time to accelerate or decelerate the rate at which the substrate (or the nozzles) moves is eliminated, and thereby improving productivity.

In this case where each droplet is applied while moving the plurality of nozzles for discharging the droplets and the substrate relative to each other, irradiation distribution of the light energy may be in an oval whose longitudinal axis shows the direction of the relative movement.

Accordingly, the droplet can be dried or sintered while the substrate (or the nozzles) relatively moves toward a next position at which a droplet will be landed.

The droplets may contain a photothermal converting material. Accordingly, the light energy that has been provided is effectively converted to thermal energy, so that the droplets can be efficiently dried or sintered. Any known photothermal converting materials can be used here as long as they convert light efficiently into heat. Examples of such materials may include, but are not limited to, the following: metal layers made of aluminum, aluminum oxide and/or sulfide; and organic layers made of carbon-black-, graphite-, or infrared-absorbing-dye-added polymer. Examples of infrared absorbing dyes may include anthraquinones, dithiol-nickel complexes, cyanines, azo cobalt complexes, diimmoniums, squaleliums, phthalocyanines, and naphthalocyanines. Further, by using synthetic resin, such as epoxy resin, as a binder, the photothermal converting material may be dissolved or dispersed in the binder resin.

An electro-optical device according to another aspect of the invention includes an electro-optical layer sandwiched between a pair of substrates, and a columnar body formed by the droplet application method.

Accordingly, an electro-optical device can be provided that has a columnar body with a small diameter and desired height accuracy.

In this case, the columnar body may be at least one of a mask part provided to the substrate so as to form a conductive part for making a first conductive part and a second conductive part that sandwich an insulation part electrically conductive, a spacer forming a gap between the pair of substrates, and a partition provided to surround the periphery of a pixel part. Accordingly, a mask part, a spacer, or a partition with a small diameter and desired height accuracy can be formed.

The electro-optical device according to the present aspect of the invention may also include a pair of electrodes, and the columnar body may be a protruded part disposed at one of the electrodes so as to emit an electron.

Accordingly, a protruded part with a small diameter and desired height accuracy can be formed.

An electronic apparatus according to yet another aspect of the invention includes the electro-optical device as a display.

Accordingly, an electronic apparatus that is excellent in display quality can be provided.

### BRIEF DESCRIPTION OF THE DRAWINGS

The invention will be described with reference to the accompanying drawings, wherein like numbers refer to like elements, and wherein:

FIG. 1 is a schematic perspective view illustrating a droplet application device according to an embodiment of the invention;

FIG. 2 is a diagram for explaining a liquid discharging principle by a piezoelectric method;

FIG. 3 is a diagram in which a light detector and a laser light source are disposed in the vicinity of a droplet discharge head;

FIG. 4 is a diagram illustrating a relationship between position and light intensity of laser light;

FIG. 5 is a diagram illustrating a second embodiment of a droplet application method according to the invention;

FIG. 6 is an exploded perspective view illustrating a liquid crystal display;

FIG. 7 is a side sectional view taken along line A-A of FIG. 6;

FIG. 8 is a diagram illustrating a procedure for manufacturing a liquid crystal display by bonding an upper substrate and a lower substrate;

FIG. 9A is a schematic block diagram illustrating an arrangement of a cathode substrate and an anode substrate included in a FED;

FIG. 9B is a pattern diagram illustrating a driving circuit included in the cathode substrate of the FED;

FIG. 10 is a schematic view illustrating the FED; and

FIGS. 11A through 11C are diagrams illustrating examples of electronic apparatuses according to yet another embodiment of the invention.

### DESCRIPTION OF THE EMBODIMENTS

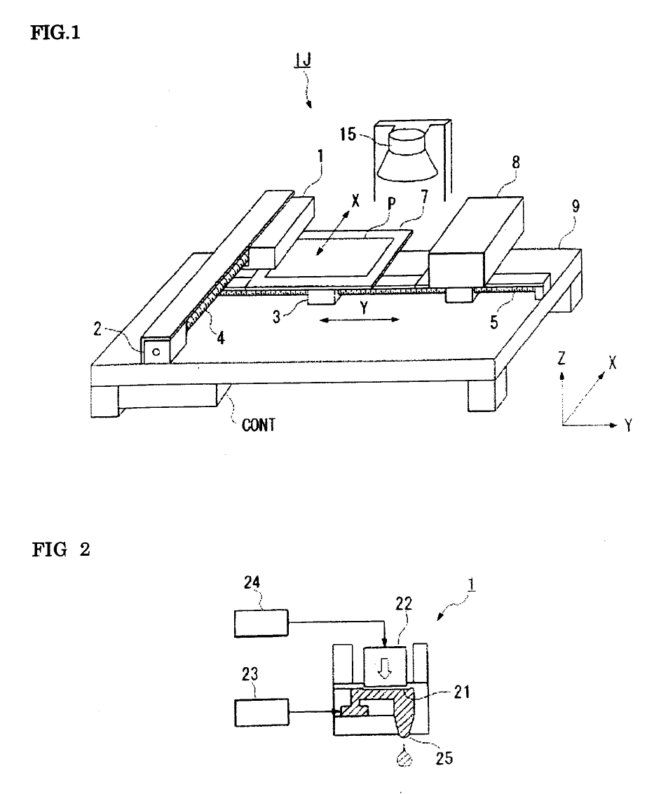

A droplet application method, a droplet application device, an electro-optical device, and an electronic apparatus according to embodiments of the invention will be described referring to FIGS. 1 through 11.

### First Embodiment

First, a droplet application device according an embodiment of the invention will be described.

As the droplet application device, a droplet discharge device (inkjet device) is used that discharges a droplet from a droplet discharge head so as to apply the droplet onto a substrate.

FIG. 1 is a perspective view illustrating a schematic structure of a droplet discharge device IJ.

The droplet discharge device (droplet application device) IJ includes a droplet discharge head 1, an X-axis direction drive axis 4, a Y-axis direction guide axis 5, a controller CONT, a stage 7, a cleaning mechanism 8, a base 9, and a heater 15.

The stage 7, which supports a substrate P to which ink (a liquid material) is provided by the droplet discharge device IJ, includes a fixing mechanism (not shown) for fixing the substrate P to a reference position.

The droplet discharge head 1 is a multi-nozzle droplet discharge head including a plurality of discharge nozzles. The longitudinal direction of the head 1 coincides with the Y-axis direction. The plurality of nozzles is disposed on a lower surface of the droplet discharge head 1 in the Y-axis direction at a constant interval. The ink containing conductive micro particles is discharged from the discharge nozzles of the droplet discharge head 1 to the substrate P supported by the stage 7.

An X-axis direction drive motor 2 is connected to the X-axis direction drive axis 4. The X-axis direction drive motor 2 is a stepping motor, for example, and rotates the X-axis direction drive axis 4 when a driving signal for the X-axis direction is supplied by the controller CONT. The X-axis direction axis 4 rotates so as to move the droplet discharge head 1 in the X-axis direction.

The Y-axis direction guide axis 5 is fixed so as not to move with respect to the base 9. The stage 7 is equipped with a Y-axis direction drive motor 3. The Y-axis direction drive motor 3 is a stepping motor, for example, and moves the stage 7 in the Y-axis direction when a driving signal for the Y-axis direction is supplied by the controller CONT.

The controller CONT supplies a voltage to the droplet discharge head 1 for controlling droplet discharge. The controller CONT also supplies a drive pulse signal to the X-axis direction drive motor 2 for controlling the movement of the droplet discharge head 1 in the X-axis direction, and a drive pulse signal to the Y-axis direction drive motor 3 for controlling the movement of the stage 7 in the Y-axis direction.

The cleaning mechanism 8 cleans the droplet discharge head 1. The cleaning mechanism 8 is equipped with a the Y-axis direction drive motor (not shown). By driving the Y-axis direction drive motor, the cleaning mechanism is moved along the Y-axis direction guide axis 5. The movement of the cleaning mechanism 8 is also controlled by the controller CONT.

The heater 15 is used for heat treatment of the substrate P by lamp annealing, and evaporates and dries solvents contained in a liquid material applied on the substrate P. Turning on and off of the heater 15 are also controlled by the controller CONT.

The droplet discharge device IJ discharges droplets to the substrate P while scanning the droplet discharge head 1 and the stage 7 supporting the substrate P relative to each other. Here, in the following explanations, the Y-axis direction is defined as a scan direction, while the X-axis direction perpendicular to the Y-axis direction is defined as a non-scan direction. The discharge nozzles of the droplet discharge head 1 are disposed in the X-axis direction serving as the non-scan direction at a constant interval. While, in FIG. 1, the droplet discharge head 1 is disposed at right angles to the moving direction of the substrate P, the angle of the droplet discharge head 1 may be adjusted so as to intersect the moving direction of the substrate P. Accordingly, the pitch between the nozzles can be adjusted by adjusting the angle of the droplet discharge head 1. The distance between the substrate P and the surface of the nozzles may be desirably adjusted.

Examples of droplet discharging techniques may include a charge control method, a pressurized vibration method, an electromechanical converting method, an electrothermal converting method, and an electrostatic attraction method. In the charge control method, an electric charge is applied to a material with a charge electrode. The material is discharged from a nozzle by controlling a flying direction of the material with a deflecting electrode. The pressurized vibration method is the method in which an ultra-high pressure of approximately 30 kg/cm² is applied to a material so as to discharge the material at the tip of a nozzle. If no control voltage is applied, the material moves straight ahead so as to be discharged from a nozzle. If a control voltage is applied, electrostatic repelling occurs in the material so as to disperse the material, whereby no material is discharged from the nozzle. The electromechanical converting method is a method using characteristics of a piezoelectric element that it deforms in response to a pulsed electric signal. The deformation of the piezoelectric element applies pressure, via an elastic material, to a space storing a material to push the material out of the space to discharge it from a nozzle.

FIG. 2 is a diagram for explaining a liquid discharging principal by a piezoelectric method.

In FIG. 2, a piezoelectric element 22 is disposed adjacent to a liquid chamber 21 storing a liquid material (function liquid). The liquid material is supplied to the liquid chamber 21 through a liquid material supply system 23 including a material tank for storing the liquid material. The piezoelectric element 22 is connected to a driving circuit 24. A voltage is applied to the piezoelectric element 22 via the driving circuit 24 so as to deform the piezoelectric element 22, and thereby deforming the liquid chamber 21 to discharge the liquid material from a nozzle 25. In this case, a strain amount of the piezoelectric element 22 is controlled by changing a value of applied voltage with a predetermined driving waveform. In addition, a strain velocity of the piezoelectric element 22 is controlled by changing a frequency of the applied voltage.

While a bubble (thermal) method in which a liquid material is discharged by bubbles generated by heating a liquid material can be employed as a droplet discharging method, the droplet discharge using the piezoelectric method has an advantage in that material composition is hardly affected, because no heat is applied to the material.

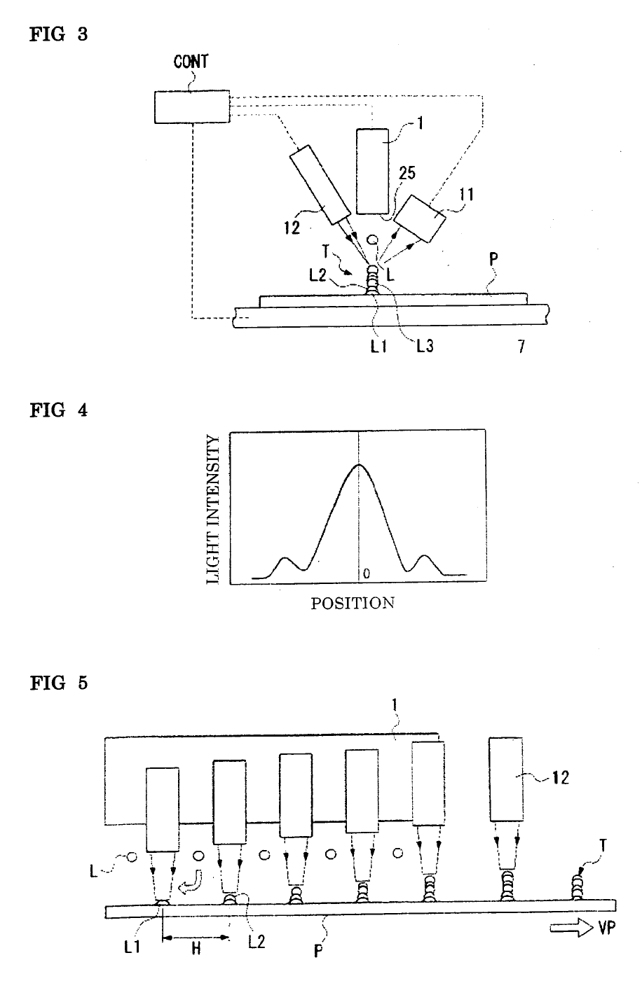

Also, in the present embodiment as shown in FIG. 3, a light detector 11 is disposed at one side in the scan direction of the droplet discharge head 1, while a laser light source 12 is disposed at the other side in the scan direction of the droplet discharge head 1 for each of the plurality of nozzles. The light detector 11 irradiates a position just under the droplet discharge head 1 with detection light so as to detect a top position of deposited droplets by detecting its reflected light. Detected results are output to the controller CONT.

Here, a method for examining a deflected light divergence, a method for examining a diffracted light distribution, etc., also can be used for detecting a top position of droplets. Also, a pre-determined relationship between the number of droplets and the top position of discharged droplets is used to calculate the top position in accordance with the number of discharged droplets. In this case, the light detector can be omitted.

The laser light source 12, in which an optical element (not shown) is provided to converge laser light, irradiates a position under the droplet discharge head 1 with laser light at an oblique incidence angle under the control of the controller CONT. The controller CONT is constructed so that a focal position of laser light, i.e., the position at which the light energy is provided by the laser light can be adjusted by adjusting the position of the optical element. In the present embodiment, a beam profile is employed in which light intensity is high at the beam center as shown in FIG. 4 in order to provide light energy effectively to a droplet having a small diameter.

Next, a droplet application method using the droplet discharge device IJ will be described.

In the method, for example, droplets of ink containing a photothermal converting material are discharged. While Ag water dispersion ink and Ag organic dispersion ink can be used for ink, droplets of Ag nanoparticle dispersion organic solvent (organic solvent; n-tetradecane) are discharged. In addition, aluminum, a metal layer made of oxide and/or sulfide of aluminum, a carbon black, an organic layer made of a polymer in which graphite or infrared ray absorbing coloring matter, etc., are added, or the like are exemplified as the photothermal converting material. Anthraquinones, dithiol-nickel complexes, cyanines, azo cobalt complexes, diimmoniums, squaleliums, phthalocyanines, naphthalocyanines, etc., can be exemplified as the infrared ray absorbing coloring matter. Furthermore, using synthetic resin such as epoxy resin, etc., as a binder, the photothermal converting material may be dissolved or dispersed into the binder resin.

Also, while YAG laser (YAG fundamental wave; a wavelength of 1064 nm), YAG laser (YAG 2nd harmonics; a wavelength of 352 nm), semiconductor laser (a wavelength of 808 nm), He—Cd laser (a wavelength of 442 nm), He—Cd laser (a wavelength of 325 nm), YVO4 laser (a wavelength of 266 nm), etc., can be used, here, YAG laser (Gaussian-beam having a beam diameter of approximately 20 pm) is used. In addition, in order to increase adhesiveness with ink, lyophilicity (high surface energy) is preliminarily applied to the substrate P by means of ultraviolet rays irradiation or O₂ plasma treatment, etc.

Here, the nozzle 25 is disposed plurally in a direction perpendicular to the drawing in FIG. 3 in accordance with a position of a columnar body to be formed.

First, the substrate P is moved, with respect to the droplet discharge head 1, to a position where a columnar body should be formed so as to be positioned. Then, a droplet L is discharged as the first droplet from the nozzle 25 of the head 1 so as to be applied on the substrate P. The applied droplet L (referred to as L1) is once rounded by surface tension. After elapsing a certain time period or a time period corresponding to the surface energy of the droplet (e.g. approximately 20 micro seconds), the droplet L1 wets and spreads until when it shows a contact angle corresponding to the surface energy of the substrate P and the surface energy of the droplet, because of the lyophilicity is given on a surface of the substrate P. Since the time period is given, the controller CONT lets the laser light source 12 irradiate laser light (e.g. 1.0 W/mm² for one millisecond) before the droplet L1 wets and spreads on the surface of the substrate P. By irradiating the laser light, the droplet L1 to which light energy is provided is dried or sintered. Irradiating the laser light to the droplet L1 needs energy amount to dry a surface so that a next (the second droplet) droplet can be deposited, is not necessarily required to be sintered.

Perticularly, the photothermal converting material is contained in the droplet L so that applied energy is efficiently converted to heat, thereby the heat being able to effectively be applied to the droplet L1 for drying or firing.

Upon fixing the droplet L1 of the first droplet, the controller CONT lets the droplet discharge head 1 discharge a droplet L2 as the second droplet on the droplet L1. After applying the droplet L2 on the droplet L1, the controller CONT immediately lets the laser light to be irradiated. Here, a position to which the laser light should be irradiated (light focusing position) is positioned higher than the position at which the laser is irradiated to the droplet L1. Therefore, the controller CONT moves the optical element of the laser light source 12 based on a top position of the droplet L2 detected by the light detector 11 so that the focal position of the laser light (the position of light energy to be provided) is changed to the top position of the droplet L2.

Also, since the droplet L2 is applied on the droplet L1, while the droplet L1 is applied on the substrate P, a reflectance at laser irradiation point is differed. Therefore, if the same energy as that given to the droplet L1 is applied to the droplet L2, heat applied to the droplet L2 is so large that the droplet L2 is possibly evaporated. Thus, the controller CONT sets the amount of light energy to be provided in accordance with the material of a landing part of a droplet. For example, light energy smaller than that given to the droplet L1 of the first droplet (e.g. 0.5 W/mm² for one millisecond) is provided to droplets after the second droplet.

Accordingly, the droplet L2 is dried or sintered by providing the light energy so that the droplet L2 can be applied and fixed in the condition in which the droplet L2 is deposited on the droplet L1.

Then, by sequentially repeating applying, drying or firing of droplets after the droplet L3 on the droplet L2 with the same manner, a columnar body T having a height of approximately several hundreds microns can be formed on the substrate P.

As mentioned above, in the embodiment, the columnar body T whose height accuracy is secured can be formed by repeating a process in which applied droplet is fixed by providing light energy, and a process in which a next droplet is applied on the fixed droplet as being deposited. Also, a girth (diameter) of the columnar body T is determined by a droplet diameter of a method for discharging a droplet in which a discharged droplet amount can be controlled with high accuracy. Also, in the embodiment, since a time period from when the droplet L is applied until light energy is provided is set based on surface energy of the landing part of the droplet L before the droplet L wets and spreads, the columnar body T having a small diameter can be formed even though the landing part is lyophilic. As a result, the columnar body T can be formed that has high adhesiveness with respect to the substrate P.

In addition, in the embodiment, the amount of light energy to be provided is adjusted based on the material of the landing part of the droplet L, whereby desired columnar body T can be stably formed without disadvantages in that the applied droplet L is evaporated, etc. Moreover, in the embodiment, a focal position of laser light is adjusted based on detected results of the light detector 11 so that light energy can effectively be provided to each applied droplet, whereby the columnar body T can rapidly and reliably be formed. Furthermore, in the embodiment, the photothermal converting material is contained in the droplet L so that light energy can effectively be converted to thermal energy, whereby applied droplets can efficiently be fixed.

### Second Embodiment

Next, a droplet application method according to a second embodiment of the invention will be described referring to FIG. 5.

In the first embodiment, the droplet L is applied while a relative movement between the droplet discharge head 1 (the nozzle 25) and the substrate P is stopped. In the embodiment, a case will be described in which droplets are discharged while the droplet discharge head 1 (the nozzle 25) and the substrate P are relatively moved (the substrate P moves to the right direction in FIG. 5).

In the embodiment, the nozzle 25 is arranged in a line in a relative movement direction described above. A relative movement speed of the substrate P and a discharge frequency of droplets are synchronized in accordance with an arrangement pitch of nozzles. More circumstantially, the relative movement speed and discharge frequency are employed that satisfy the formula (1) below:
H=VP/f formula (1)
where H is the arrangement pitch, VP is the relative movement speed of the substrate P, and f is the discharge frequency of the droplet L.

By discharging droplets under the condition that satisfies the formula 1, the columnar body T in which droplets are deposited in the number of nozzles is formed on the substrate P.

Also, in the embodiment, the number of droplets that are deposited is given every nozzle. Thus, the laser light source 12 is disposed at a position elevated to a height corresponding to the number of droplets. Here, only a focal position of the optical element may be changed without changing the height of the laser light source 12.

Also, the laser light source 12 has an irradiation distribution of an oval shape whose longitudinal direction is the relative movement direction so that a landing part of a droplet (on the substrate P or on the applied droplet) is overlapped with an end part of a beam. Therefore, the droplet L can be dried or sintered, and fixed while the applied droplet L is reached a next landing part by moving the substrate P.

In the embodiment, in addition to obtain the same operational advantages as those of the first embodiment, more efficient production can be realized because the substrate P is not required to be stopped every formation of the columnar body T so that waste of time to accelerate or decelerate can be eliminated.

In the embodiment, in a case where the columnar body T is formed in multiple columns, the nozzle and the laser light source are arranged in multiple numbers perpendicular to the drawing.

Also, in the first and second embodiments, the laser light source is arranged each nozzle. But, an array of beam spots may be formed using a diffraction grating, while laser light may be distributed using an optical fiber.

### Third Embodiment

Next, a liquid crystal display (electro-optical device) manufactured by the droplet application method will be described.

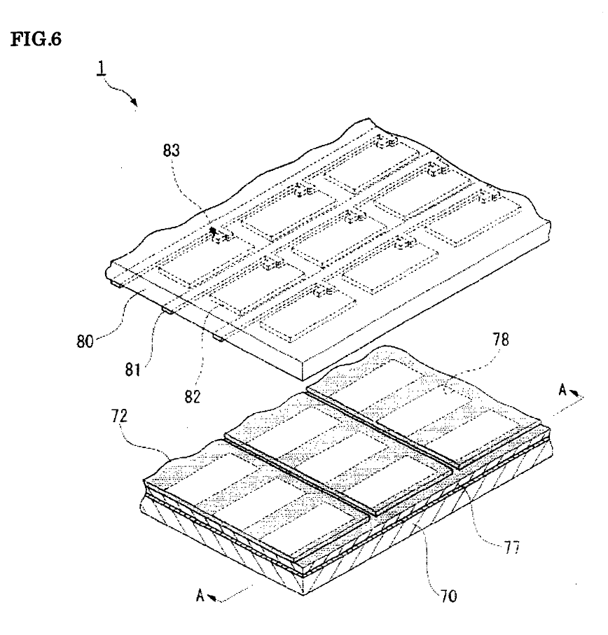

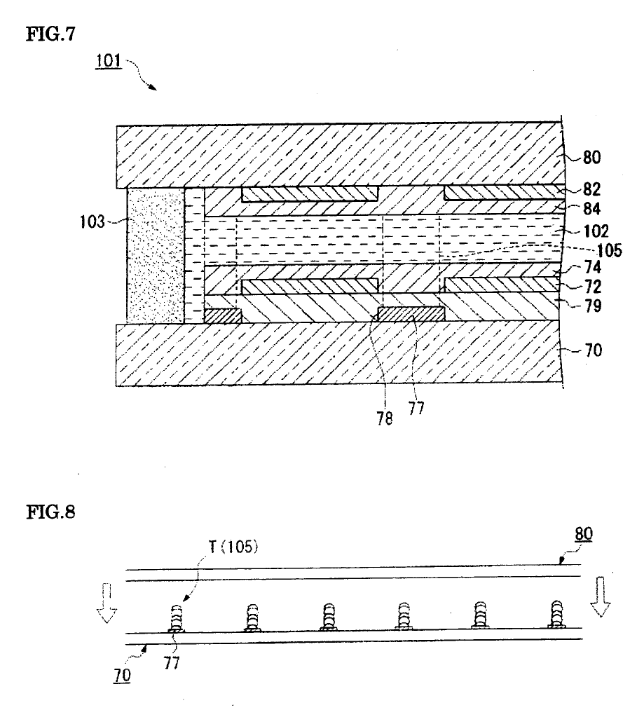

First, a schematic construction of a liquid crystal display will be described referring to FIG. 6 and FIG. 7. FIG. 6 is an exploded perspective view of a liquid crystal display, and FIG. 7 is a side sectional view taken along line A-A of FIG. 6. As shown in FIG. 7, a liquid crystal display (electro-optical device) 101 is constructed in which a liquid crystal layer (electro-optical layer) 102 is sandwiched between a lower substrate (facing substrate) 7 and an upper substrate (element substrate) 80. Nematic liquid crystal, etc., is employed for the liquid crystal layer 102, while twisted nematic (TN) mode is employed as an operation mode of the liquid crystal display 101. Liquid crystal material other than the above-mentioned ones can also be employed, while operation modes other than the above-mentioned one can also be employed. An active matrix liquid crystal display using TFD element as a switching element will be described as an example. However, the invention can also be applied to other active matrix liquid crystal displays than the device, and passive matrix liquid crystal displays.

As shown in FIG. 6, in the liquid crystal display 101, the lower substrate 70 and the upper substrate 80 made of a transparent material such as glass, etc., are arranged facing each other. A plurality of scan lines 81 is formed inside the upper substrate 80. A plurality of pixel electrodes 82 made of a transparent material such as ITO, etc., is arranged in a matrix at the side of the scan lines 81. The pixel electrode 82 is connected to each scan line 81 via a TFD element 83. The TFD element 83 is composed of a first conductive film that is formed on a surface of the substrate and composed substantially of Ta, an insulation film that is formed on a surface of the first conductive film and composed substantially of Ta₂O₃, and a second conductive film that is formed on a surface of the insulation film (MIM structure). Then, the first conductive film is connected to the scan line 81, while the second conductive film is connected to the pixel electrode 82. As a result, the TFD element 83 functions as a switching element to control an electrical connection to the pixel electrode 82.

In contrast, inside the lower substrate 70, a plurality of facing electrodes 72 made of a transparent material such as ITO, etc., is formed. The facing electrodes 72 are formed in a stripe like perpendicular to the scan lines 81. Upon supplying a scan signal to the scan line 81 and a data signal to the facing electrode 72, an electric field is applied to the liquid crystal layer with the pixel electrode 82 and the facing electrode 72 both of which are faced. Therefore, a forming region of each pixel electrode 82 constructs a pixel region.

In order to prevent light from being leaked from pixel regions adjacent each other, a light shading film 77 called a black matrix is formed inside the lower substrate 70. The light shading film 77 is composed of black chromium metal having light absorption property, etc. The light shading film 77 also includes a plurality of openings 78 corresponding to each pixel region. The openings 78 allow light from a light source to be incident on image regions, and image light to be exited from the image regions. Then, as shown in FIG. 7, an insulation film 79 that is transparent is formed so as to cover the light shading film 77. Additionally, the facing electrodes 72 are formed inside the insulation film 79.

Also, an alignment film 74 is formed so as to cover the pixel electrode 82, while an alignment film 84 is formed so as to cover the facing electrode 72. The alignment films 74 and 84, which control an alignment condition of liquid crystal molecules when no applied electric field is applied, are composed of an organic polymer material such as a polyimide, etc., and rubbing processing is carried out on the surface thereof. Accordingly, when no electric field is applied, the liquid crystal molecules near the surface of the alignment films 74 and 84 are aligned so as to be nearly in parallel with the alignment films 74 and 84, with the longitudinal direction thereof being aligned to the rubbing processing direction. In addition, the rubbing processing is carried out to each of the alignment films 74 and 84 so that the alignment direction of the liquid crystal molecules near the surface of the alignment film 74 and the alignment direction of the liquid crystal molecules near the surface of the alignment film 84 differs by a predetermined angle. As a result, the liquid crystal molecules that compose the liquid crystal layer 102 are spirally layered along the thickness direction of the liquid crystal layer 102.

Moreover, in the both substrates 70 and 80, the their peripheral portions are bonded by a sealing member 103 made of an adhesive such as a thermosetting type or an ultraviolet-cured type, etc. Then, the liquid crystal layer 102 is sealed in the space surrounded by the both substrates 70 and 80, and the sealing member 103. The thickness (cell gap or clearance) of the liquid crystal layer 102 is controlled by a spacer 105 disposed between the both substrates 70 and 80. The spacer 105 is formed on the light shading film 77 with a height of approximately 5 μm by using the droplet application method with UV cured resin.

In contrast, outside the lower substrate 70 and the upper substrate 80, polarizers (not shown) are provided. Each polarizer is provided with a condition in which each polarization axis (transmission axis) differs from each other by a predetermined angle. Moreover, a backlight (not shown) is provided outside an incident side polarizer.

Then, the light irradiated from the backlight is converted into linearly polarized light along the polarization axis of the incident side polarizer, and is incident on the liquid crystal layer 102 from the lower substrate 70. The linearly polarized light, in the process of transmitting the liquid crystal layer 102 in the condition of no electric field being applied, rotates by a predetermined angle along the twist direction of the liquid crystal molecules, and transmits an outgoing side polarizer. Accordingly, white display is carried out when no electric field is applied (normally white mode). In contrast, when an electric field is applied to the liquid crystal layer 102, the liquid crystal molecules are re-aligned perpendicular to the alignment films 74 and 84 along the electric field direction. In this case, the linearly polarized light that is incident on the liquid crystal layer 102 does not rotate, so that the light does not transmit the outgoing side polarizer. Accordingly, black display is carried out when no electric field is being applied. In addition, gray-scale display can be carried out corresponding to strength of the applied electric field.

The liquid crystal display 101 is constructed as described above.

In the embodiment, the spacer 105 is applied on a surface of the light shading film 77 of the lower substrate (hereinafter simply referred to as the “substrate”) 70 by the droplet application method. For the laser light source of the embodiment, ultraviolet light laser light can be used as follows: He—Cd laser (a wavelength of 442 nm), He—Cd laser (a wavelength of 325 nm), YVO₄ laser (a wavelength of 266 nm), etc.

In the embodiment, in order to secure the strength of the spacer, light energy is provided by irradiating ultraviolet light after droplets are spread.

Specifically, a droplet having a diameter of approximately 15 μm is applied on the light shading film 77. Ultraviolet light is irradiated after one millisecond from landing of the droplet. As a result, one layer of the droplet forms a thickness of approximately one pm. In this case, once a hardening reaction is started by the UV irradiation, the reaction proceeds to the final stage. Thus, curing is not required after the irradiation. By depositing droplets about five layers (five droplets), as schematically shown in FIG. 8, the columnar body T serving as the spacer 105 can be formed on the light shading film 77 of the lower substrate 70 with a height of approximately 5 μm and accuracy being secured.

Subsequently, liquid crystal is applied by the droplet application method. As shown in FIG. 8, by bonding to the upper substrate 80, a liquid crystal display 101 having an accurate gap can be manufactured.

Moreover, in liquid crystal displays, light shading masks (mask part) and partitions for discharging droplet are also applicable in addition to the spacer 105.

The light shading mask provided to a substrate is used for forming a contact hole in order to bury a plug of a conductive material in an interlayer insulation layer in a case where an upper wiring pattern serving as a first conductive part and a lower wiring pattern serving as a second conductive part are electrically connected via an interlayer insulation layer (insulation part).

Specifically, a lower wiring layer is formed on a substrate by etching, etc. A columnar body serving as a mask part is formed at a position corresponding to a contact hole on the lower wiring layer by the droplet application method. Then, an interlayer insulation layer is formed on the lower wiring layer. Subsequently, a contact hole can be formed in the interlayer insulation layer by removing the columnar body using etching, etc.

Then, after forming the contact hole in this way, a plug is formed by filling a conductive material in the contact hole. Next, by forming an upper wiring layer on the interlayer insulation layer so as to contact the plug, the lower wiring layer and the upper wiring layer can electrically be connected via the plug in the contact hole.

In addition to this, partitions can also be formed by the droplet application method in a case where a partition called a bank is formed so as to surround a periphery of a pixel part in order to avoid a color mixing, etc., when a droplet containing a coloring material is applied to a region corresponding to a pixel in a production of color filters used for liquid crystal displays. Moreover, in addition to liquid crystal displays, partitions are also applicable that are used for forming luminance layers by the droplet application method in a production of organic EL devices.

### Fourth Embodiment

Next, a field emission display (hereinafter referred to as “FED”) will be described that is an electro-optical device equipped with a field emission element (electron emission element) manufactured by the droplet application method.

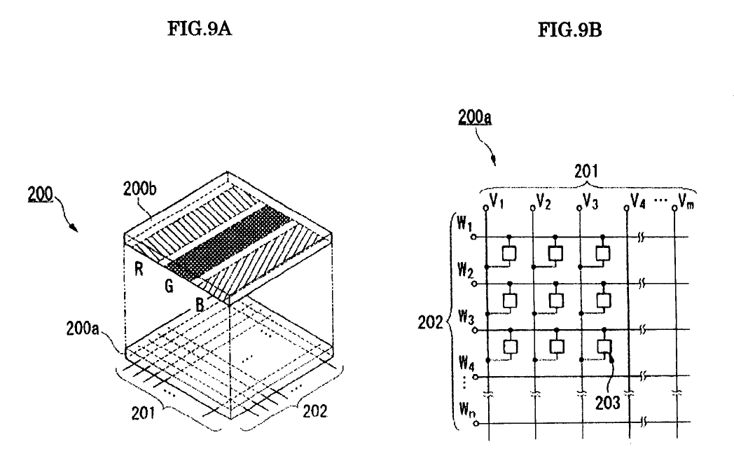

FIG. 9 shows explanatory diagrams of FED. FIG. 9A is a schematic block diagram illustrating an arrangement of a cathode substrate and an anode substrate included in FED. FIG. 9B is a pattern diagram illustrating a drive circuit included in the cathode substrate of FED.

As shown in FIG. 9A, a FED (electro-optical device) 200 is constructed in which a cathode substrate 200a and an anode substrate 200b are disposed facing each other. The cathode substrate 200a, as shown in FIG. 9B, includes a gate line 201, emitter line 202, and a field emission element 203 connected to the gate line 201 and the emitter line 202, i.e., constructs so-called a simple matrix drive circuit. In the gate line 201, gates signals V₁, V₂, . . . , Vₘ are supplied, while in the emitter line 202, emitter signals W₁, W₂, . . . , Wₘ are supplied. Also, the anode substrate 200b includes fluorescent materials of RGB that has a property of emitting light upon receiving electrons.

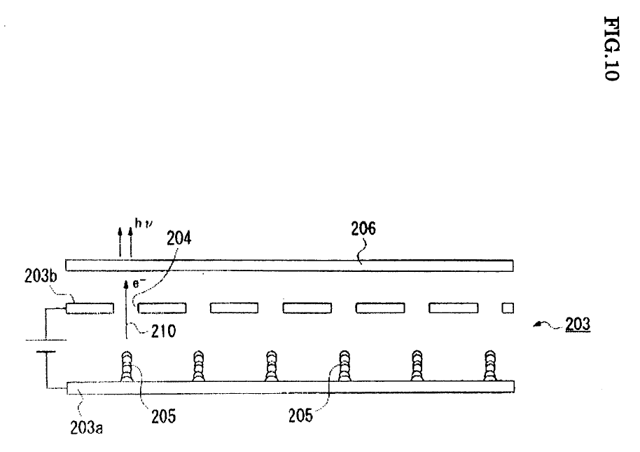

As shown in FIG. 10, the field emission element 203 is constructed, including an emitter electrode 203a connected to the emitter line 202, and a gate electrode 203b connected to the gate line 201. Moreover, the emitter electrode 203a includes a protruded part called an emitter tip 205 whose diameter is decreased from adjacent to the emitter electrode 203a toward the gate electrode 203b. A hole 204 is formed at a position of the electrode 203b, the position corresponding to the emitter tip 205. The tip of the emitter tip 205 is disposed within the hole 204.

In such the FED 200, a voltage is applied between the emitter electrode 203a and the gate electrode 203b by controlling the gate signals V₁, V₂, . . . , Vₘ in the gate line 201, and the emitter signals W₁, W₂, . . . , Wₘ in the emitter line 202. An electron 210 is moved from the emitter tip 205 toward the hole 204 by an electric field so that the electron 210 is emitted from the tip of the emitter tip 205. Here, the electron 210 hits a fluorescent material 206 of the anode substrate 200b to emit light, so that the FED 200 can be driven as desired.

In the FED as mentioned above, the emitter tip 205 serving as a cathode is formed by the above-mentioned droplet application method. For ink to be discharged, one can be used in which materials having a low work function (K, Ca, ITO, Ag—O—Cs, In Ga/As, etc.) are dispersed as fine particles. In addition, a method can also be employed in which metal (Ag and Cs, In and Sn, etc.) is ionized so as to be discharged as a water solution and is oxidized by a laser when drying. Furthermore, a method can be employed in which carbon nanotubes are dissolved in an organic solvent so as to be applied.

In all methods, a cathode having a tapered shape toward its tip (the emitter tip 205) is formed by forming and fixing a columnar body deposited with droplets by means of the droplet application method according to the invention, thereby enabling electrons to be easily emitted. Moreover, when depositing droplets, the tip can be further thinned by employing a method in which an ink amount (discharged droplets amount) is discharged so that it is further decreased, more adjacent to the upper part. For example, a drive voltage of a piezoelectric element is decreased or a driving waveform is changed for a fine dot. In addition, since a discharge amount of a droplet can be controlled by the droplet application method, a cathode can be formed with high accuracy without a variation between pixels.

### Fifth Embodiment

Next, electronic apparatuses equipped with the electro-optical device according to the above-mentioned embodiments will be described.

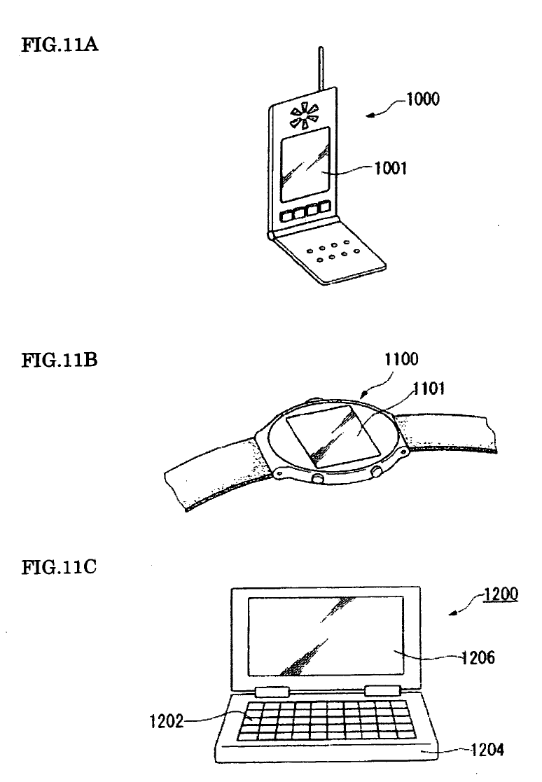

FIGS. 11A through 11C show examples of electronic apparatuses according to yet another embodiment of the invention.

Electronic apparatuses in the examples are equipped with electro-optical devices (a liquid crystal display, an organic EL device, and a FED) manufactured by the droplet application method according to the invention as display means.

FIG. 11A is a perspective view illustrating an example of cellular phones. In FIG. 11A, reference numeral 1000 denotes a body of the cellular phone (electronic apparatus), and reference numeral 1001 denotes the display using the above-mentioned electro-optical device.

FIG. 11B is a perspective view illustrating an example of wristwatch electronic apparatuses. In FIG. 1B, reference numeral 1100 denotes a body of the wristwatch (electronic apparatus), and reference numeral 1101 denotes the display using the above-mentioned electro-optical device.

FIG. 11C is a perspective view illustrating an example of portable information processing devices such as word processors and personal computers. In FIG. 11C, reference numeral 1200 denotes a information processing device (electronic apparatus), reference numeral 1202 denotes an input section such as a keyboard, reference numeral 1204 denotes a body of the information processing device, and reference numeral 1206 denotes a display using the above-mentioned electro-optical device.

Each electronic apparatus shown in FIGS. 11A through 11C can be an electronic apparatus having a protruded part that has a small diameter with desired height accuracy, and high quality in display characteristics because the electro-optical device according to the invention is included as display means.

While the preferred embodiments according to the invention are described referring to the accompanying drawings, it is understood that the invention is not limited to these examples. In the above-mentioned examples, the shape of each component or combinations, etc., is an example, and various modifications can be made based on design demands, etc., within the scope not departing from the gist of the invention.

For example, as for electro-optical devices manufactured by the droplet application method according to the invention, other than the above-mentioned, for example, a micro lens provided on a face light emitting laser for adjusting focal distance can be formed as a columnar body by the droplet application method according to the invention so as to reduce a light emitting angle, or a protruded part of a finder screen used for adjusting a pint of cameras can be manufactured by the droplet application method according to the invention. Other than those, projector screens, micro machines are also applicable.

What is claimed is:

1. A droplet application method for discharging and applying a plurality of droplets onto a substrate, comprising:
repetition of:
providing light energy to a droplet that has been applied; and
applying another droplet onto the droplet to which the light energy has been provided.

2. The droplet application method according to claim 1, a time period from applying each droplet to providing the light energy being set based on surface energy of the droplet that has been applied.

3. The droplet application method according to claim 2, the light energy being provided before the droplet spreads with the surface energy on a part onto which the droplet has been landed.

4. The droplet application method according to claim 2, an amount of the light energy to be provided being determined by a material of a part onto which the droplet has been landed.

5. The droplet application method according to claim 1, further comprising:
detecting a top position of the droplets that have been deposited; and
adjusting a position at which the light energy is provided based on the detected top position.

6. The droplet application method according to claim 1, further comprising:
applying each droplet while moving a plurality of nozzles for discharging the droplets and the substrate relative to each other, a rate of relative movement of the substrate and a frequency at which the droplets are discharged being synchronized depending on a pitch of the nozzles.

7. The droplet application method according to claim 6, irradiation distribution of the light energy being in an oval whose longitudinal axis shows a direction of the relative movement.

8. The droplet application method according to claim 1, the droplets containing a photothermal converting material.

9. A droplet application device that applies a droplet to the substrate by the droplet application method according to claim 1.

10. An electro-optical device, comprising:
an electro-optical layer sandwiched between a pair of substrates, and
a columnar body formed by the droplet application method according to claim 1.

11. The electro-optical device according to claim 10, the columnar body being at least one of a mask part provided to the substrate so as to form a conductive part for making a first conductive part and a second conductive part that sandwich an insulation part electrically conductive, a spacer forming a gap between the pair of substrates, and a partition provided to surround a periphery of a pixel part.

12. The electro-optical device according to claim 10, further comprising:
a pair of electrodes, the columnar body being a protruded part disposed at one of the electrodes so as to emit an electron.

13. An electronic apparatus, comprising:
the electro-optical device according to claim 10 as a display.
